(19) United States
(12) Patent Application Publication
(10) Pub. No.: US 2002/0135515 A1
(43) Pub. Date: Sep. 26, 2002

(54) Information system for travellers

(76) Inventors: Paul J. Rankin, Horley (GB); Paul R. Simons, Redhill (GB)

Correspondence Address: PHILIPS ELECTRONICS NORTH AMERICAN CORP, 580 WHITE PLAINS RD, TARRYTOWN, NY, 10591, US

(21) Appl. No.: 10/101,310

(22) Filed: Mar. 19, 2002

(30) Foreign Application Priority Data
Mar. 20, 2001 (GB) 0106846.9
Sep. 13, 2001 (GB) 0122229.8
Oct. 17, 2001 (GB) 0124884.8

(51) Int. Cl. G01S 1/00; G08B 21/00

(52) U.S. Cl. 342/385; 340/686.1

(57) ABSTRACT

A data transmission system for a transportation platform (100) comprising a transport beacon (102) and a user terminal (104), the transport beacon and user terminal being carried on the transportation platform (100), the transport beacon operable to access data associated with a geographical position (106), to receive a signal relating to the present geographical position (108) of the transportation platform and to exchange the data (110) with the user terminal in response to the signal.

The present invention relates to a system for the delivery of services and advertising to travellers and to methods utilising such a system.

Persons travelling desire to know information regarding their destination and also information regarding places en route to the destination. This desire applies both to the tourist who is new to a locality and to the frequent traveller, for example a commuter, although the needs of these types of user will be different. Information may therefore range from general advertising to more personalised services specific to the interests of the traveller.

The CoolTown research project (Hewlett-Packard Laboratories, http://www.cooltown.com) discloses a World Wide Web model for supporting nomadic users based on a presumed convergence of Web technology, wireless networks and portable devices. It proposes tying Web resources to physical objects and places with users interacting with those resources using portable information appliances such as PDAs and laptops. The user interaction is by surfing URLs associated with the physical objects and places. Recognising that there will not always be beacons in a locality to make URL's available, a development of the CoolTown has been proposed, as described in “Websigns: Hyperlinking Physical Locations to the Web” S. Pradhan et al. IEEE Computer, August 2001, pp.42-48. These Websigns are provided in periodic downloads to a GPS-equipped handset and comprise URL's linked to geographical locations: when the user is at a particular location (as detected by the GPS), the handset presents the related URL's to the user, without requiring interaction with a beacon at that location.

A disadvantage of CoolTown is the limitation to a Web-specific mode of operation. A further drawback is the inability to push content to a user; Web surfing is predominantly a “content pull” process in which a user specifically requests Web pages and the like. A yet further drawback is the inherent inability of some portable devices to adequately support Web-based interaction.

A problem readily observed by travellers riding a transportation platform is the lack of robustness of communication. A partial remedy used by mobile phone operators is to install a widespread and dense basestation infrastructure at great cost and with correspondingly increased opposition to the siting of basestation antenna masts within local communities. Yet, such systems still exhibit communication ‘blackspots’, most notably in tunnels, remote areas or areas with difficult propagation characteristics.

In another aspect, a service operator wants to achieve maximum service coverage (service accessibility) for minimum infrastructure investment. The operator may wish to offer services relating to entities which are positioned physically densely, for example each and every store located in a town. Clearly it is costly and impracticable to install a conventional fixed basestation or other infrastructure to support such a scenario.

A traveller inherently wishes to know his/her present geographical position en route to his/her final destination. Most portable devices are not equipped to access geographical position data; even if so equipped, access may be restricted by the route of the transportation platform the traveller is using, for example GPS reception is impossible on an underground railway or within a road tunnel.

The traveller may further desire to know an estimate of time of arrival at his/her specific destination: this is an example of personalised travel information that could be available to a traveller on a public transportation platform such as a train or bus. Further examples of personalised travel information might include an indication of the correct stop at which to alight from the transportation platform, data on best routes, fare tariffs, etc.

The traveller also has an interest in the journey itself, for example to access information on places of interest along the way, perhaps for reference in the future. However, not everything of interest to travellers is necessarily interesting to every traveller. A common failing of advertising is that it targets the wrong people. A further hindrance are the rudimentary user interfaces of some portable devices (user terminals) which make complex queries impossible or very burdensome.

It is an object of the present invention to mitigate these and other problems through an improved system and methods to provide information for travellers on a transportation platform.

In accordance with the present invention there is provided a data transmission system for a transportation platform comprising a transport beacon and a user terminal, the transport beacon and user terminal being carried on the transportation platform, the transport beacon operable to access data associated with a geographical position, to receive a signal relating to the present geographical position of the transportation platform and to exchange said data with the user terminal in response to said signal.

For the duration of the journey on a transportation platform a beacon, referred to herein as a transport beacon, is able to interact with a user terminal belonging to a person riding the transportation platform. Examples of transportation platforms include, but are not limited to, bus, truck, train, taxi, private car, aeroplane and ship. The user terminal is personal to the user in that it is carried on and off the transportation platform and while on the transportation platform it is capable of interacting with the transport beacon also located on the transportation platform. The user terminal may also be capable of interacting or communicating with other entities in addition to the transport beacon, for example it may communicate with mobile phone basestations using GSM or be capable of connecting to similarly equipped devices in range using wireless means for example, but not limited to, Bluetooth, IEEE802.11 and IrDA, or using wired means, for example, but not limited to, USB, Firewire and RS232. Examples of user terminals include, but are not limited to, a mobile phone, a PDA (for example, PalmPilot™) and a laptop PC.

By use of a transport beacon travelling on the transportation platform, which transport beacon provides signals and services in dependence on the current location of the platform, a number of fixed beacons providing local services along the route travelled may be emulated, without the user noticing any difference to travelling through an area of such local beacons, and without requiring the infrastructure and hardware to be installed for all those beacons. In addition to the current geographical location, the current date/time may also be taken into account when determining those messages to be sent by the transport beacon to emulate the fact that not all beacons along a route might be transmitting all of the time; for example, a beacon advertising special offers at a restaurant may only make those offers available at lunchtimes.

Further in accordance with the present invention there is provided a transport beacon for a transportation platform comprising a data processing unit, a first communications port operable to support communications with a user terminal, a second communications port operable to receive a signal relating to the present geographical position of the transportation platform and a third communications port operable to access data associated with a geographical position and to exchange said data with the user terminal in response to said signal.

A transport beacon resides on a transportation platform and has the capability to communicate with user terminals also travelling on the transportation platform. Clearly, to allow coverage of the entire user-space of the transportation platform several transport beacons may be necessary; in this instance the transport beacons would be interconnected and act as a single transport beacon for the purpose of the system of the present invention. Suitably, the transport beacon is one of several beacons that a user may interact with via the user terminal, with other (fixed) beacon systems being provided in, for example, shopping malls and other communal areas. In such a case, it is preferable that the transport beacon communicates with the user terminal in the same manner as these other beacons so that the user is not required to reset or reconfigure the terminal when boarding and alighting from the transportation platform.

The transport beacon may incorporate several means of communication with user terminals—to accommodate a range of user terminal embodiments, each with its own means of communication. Wireless is a typical means of such communication; the advent of Bluetooth™ makes this short range radio system a favoured communication method for linking the transport beacon and user terminal. Other wireless methods include, but are not limited to: IEEE802.11 (in conventional and limited range formats), RF-Lite and infrared (e.g. IrDA). Wired methods may also be used including, but not limited to, for example Ethernet, RS232, USB and IEEE1394.

The transport beacon receives a signal relating to the present geographical position of the transportation platform. This signal may be provided by a system related to the management of the transportation platform, for example data specific to the routing and/or signalling in relation to a network or locale within which the transportation platform operates. Alternatively, the transportation platform or the transport beacon itself may incorporate a GPS unit to provide a signal relating to the present geographical position to the system. A yet further alternative is that the transport beacon receives geographical position data from a basestation beacon, as discussed below. The transport beacon may include storage to cache data associated with a geographical position; this is typically when such data is furnished via a sporadic and temporary data connection for example a basestation beacon. The store may also cache user-specific response data (for example relating to user interactions with data provided by the system). The transport beacon may further comprise a communications port operable to support communications with a basestation beacon.

The system of the invention may further comprise a basestation beacon, the basestation beacon operable to communicate and exchange data with the transport beacon. The basestation beacon is typically physically situated somewhere nearby the route of the transportation platform carrying the transport beacon such that the transport beacon may be in range of the basestation beacon during a part of its journey. Preferably, to facilitate a good period of data exchange it is advantageous that the basestation beacon is situated at a stop on the route of the transportation platform. This is not essential however and any convenient and suitable location of the basestation beacon is possible. Communication between the basestation beacon and transport beacon can be via any suitable means; although wireless is preferred (radio or infrared) for new installations with minimal infrastructure, more established systems with an established backend communications infrastructure (for example railway or tram systems with communications to and from the vehicle carried via the rails or overhead power cables) may use a wired arrangement. To maximise data exchange between the basestation beacon and the transport beacon on board a transportation platform a fast connection-establishment protocol is preferred; a proprietary communications solution is also possible since the basestation beacon and transport beacon are elements within a closed system (unlike the user terminal which may also work within other systems as well as the system of the present invention). The basestation beacon may utilise the same communications means to also allow it to communicate with user terminals of foot travellers and the like. Alternatively, another communications means may be used for this purpose.

Further in accordance with the present invention there is provided a basestation beacon comprising a data processing unit, a store for data associated with a geographical position and a communications port operable to support communications with a transport beacon. The basestation beacon may further comprise storage for data downloaded from a transport beacon for example data representing responses from one or more users. The fact that the basestation beacon resides on a route of the transportation platform and that the data is generally durable or only needs updating infrequently may provide the following advantages—to save infrastructure costs the basestation beacon can be updated via a transport beacon residing on a transportation platform rather than needing to connect to a conventional network. Such a method of functioning might include firstly, uploading to the transport beacon update data from a first basestation beacon; secondly, storing the update data within the transport beacon; and thirdly, downloading to a second basestation beacon the update data from the transport beacon. Thus a basestation beacon may simply require a power supply in order to function as a fully capable entity within the system of the present invention. A suitable power supply may be mains or solar power as is well known to the skilled person. A further option of course remains whereby the basestation beacon may be connected to a network, the network operable to exchange data with the basestation beacon. The network connection may utilise standard wired (for example, but not limited to, Ethernet, X25 and optic-fibre) or wireless (for example, but not limited to, IEEE802.11, IrDA, GSM and GPRS) networking technologies as are commonplace in the art.

A basestation beacon may also be programmed with a (fixed) code signal representing its present geographical position; such a code may be communicated to the transport beacon to represent the signal relating to the present geographical position of the transportation platform. For convenience, the signal format may conform to the GPS standard.

Further in accordance with the present invention there is provided a use of a transport beacon to deliver user services and advertising to travellers on a transportation platform, the use comprising:

the accessing of data associated with a geographical position of the transportation platform;

the reception of a signal relating to the present geographical position of the transportation platform; and

the exchange of said data with a user terminal residing on the transportation platform in dependence of the present geographical position of the transportation platform. The dependence on the present geographical position may be coupled with information as to the route or direction of the platform travel, as well as its speed, so that the data exchanged relates to locations shortly to be arrived at. The platforms speed may also be used to control the granularity of information transfer, that is to say the higher the speed, the further apart will be the locations for which information is provided so that the user does not become overloaded with data.

Further in accordance with the present invention there is provided a method for delivering personalised data services and adverts to travellers, the method supported by a transport beacon and a user terminal residing on a transportation platform, the method comprising the steps of:

a) accessing data associated with a geographical position along the route of the transportation platform;

b) receiving a signal related to the present geographical position of the transportation platform; and

c) exchanging data related to a geographical position along the route of the transportation platform between the transport beacon and the user terminal in response to said signal.

The transport beacon can acquire data related to geographical positions via any convenient means including, but not limited to, portable data carrier (for example CD-ROM, floppy disk or memory cartridge), download from a network connection (including Internet) or download from a basestation beacon. The transport beacon may incorporate storage for data related to a geographical position along the route of the transportation platform and for user data within the transport beacon. Typically, the transport beacon would exchange data with a basestation beacon: on the one hand receiving personalised data services and adverts for travellers in the form of data relating to one or more geographical positions, optionally including public address or news announcements in different user-terminal-selectable languages, and on the other hand sending user-specific data to the service operator, such data might comprise user demographics or profiling as well as advert response data. This data may be exchanged with the service operator by collection from one or more basestation beacons using a transportation platform or by network connection to the basestation beacons.

Further in accordance with the present invention there is provided a method for creating virtual advertising space comprising the steps of:

a) providing to a transport beacon on a transportation platform advertising material relating to a geographical position;

b) detecting the present geographical position of the transportation platform; and

c) transmitting to a user terminal on the transportation platform advertising material in response to the present geographical position.

The transmission of material to a user is in accordance with the resolution of the sensing of geographical position. Where this is for example every stop of a scheduled route, then the transmission will be adapted at each stop. However, the transmission can be adapted at more frequent intervals where (a) data associated with more accurately defined geographical positions exists corresponding to the present geographical position of the user terminal (transportation platform) and (b) the signal relating to the present geographical position is updated more frequently (that is, a more fine resolution sensing of the present geographical position); such a finer resolution signal may be furnished for example in the case where a GPS unit is mounted on the transportation platform. In practice, every geographical position increment along a route could have its own virtual advertising space, the increments being in principle to the same resolution as GPS or a similar geographical position sensing system deployed in the system of the invention. In addition, for each geographical position there may be several such virtual advertising spaces each addressing a different target (user) group.

In an arrangement such as that above, unlike the above-mentioned CoolTown Websigns system, the user terminal is neither required to possess a location determining capability, nor to store an array of URL's associated with locations, yet location specific messages may still be pushed to the user terminal.

Further in accordance with the present invention there is provided a method for advertising to passengers on a transportation platform comprising the steps of:

a) providing to a transport beacon on the transportation platform advertising material relating to a user profile;

b) receiving at the transport beacon a user profile from a user terminal;

c) selecting from the available advertising material at the transport beacon material appropriate to the user profile; and

d) transmitting to the user terminal advertising material associated with the user profile.

The selection of material appropriate to the user profile at step c) above may, for example, comprise an anticipation of the users destination (based on past journeys) with selection of information about restaurants at or near the expected point of alighting, optionally coupled with reminders or suggestions to the user to get off the transportation platform at the appropriate stop. The transportation platform, by exchanging data with a user terminal on the transportation platform, may be able to acquire profile information relating to that user, for example restaurant preferences, habits, lifestyle and demographics or journey routing information. Such data can be matched with advertising material held in the transport beacon corresponding to one or more profiles identified by advertisers and sponsors. Matching advertisements and other information may then be sent to the user terminal.

Further in accordance with the present invention there is provided a method for identifying to a user a store associated with an advertisement comprising the steps of:

a) sending an advertisement from the transport beacon to a user terminal;

b) receiving at the transport beacon a user identity data accompanying a user response to said advertisement;

c) forwarding the user identity data from the transport beacon to a basestation beacon;

d) sending the user identity data from the basestation beacon to a store node; and

e) receiving the user identity data at the store node and the store node responding to the user.

In the above method, it is assumed that a user will have no objections to their identity being forwarded to the store node: if, however, this is unacceptable to users, an additional interactive step between the user terminal and transport beacon could ask the user to confirm their consent to the sending of their identity. A store node may interact with the system of the invention such that it can receive a user identity and respond accordingly. The store node may itself be a basestation beacon, in accordance with the present invention, or it may connect using a standard interconnection (wired or wireless) to a basestation beacon; the latter arrangement more easily facilitates the sharing of a basestation beacon among several establishments. One possible response is where the store node is operable to display in a prominent fashion the user identity on a display physically proximate to the store. Another alternative is that the user identity data comprises a user mobile phone number which is dialled by the store node to call the user who is travelling nearby.

Further in accordance with the present invention there is provided a method for configuring billboard advertising to correspond with a profile of nearby travellers comprising the steps of:

a) providing a set of pre-defined user profiles;

b) providing a set of billboard locations;

c) receiving by a transport beacon a user profile from a user terminal;

d) associating the received user profile with a user profile group;

e) determining an appropriate user profile group corresponding to the present user population riding the transportation platform;

f) detecting the present geographical position of the transportation platform;

g) detecting the proximity of a billboard to the transportation platform;

h) exchanging said appropriate user profile group identity between the transport beacon and a basestation beacon;

i) exchanging said appropriate user profile group identity between the basestation beacon and the billboard; and

j) displaying on the billboard an advertisement corresponding to said appropriate user profile group identity.

In recent years, billboard advertising has evolved where prime sites are fitted with time-rotating advertisements in order to increase revenue. The present method enhances this concept by providing a matching to a profile of nearby travellers and a billboard advertisement corresponding to that profile. In this way the impact of billboard advertising may be improved.

Further in accordance with the present invention there is provided a method for advance notification of users of upcoming information on the route of a transportation platform comprising the steps of:

a) providing to a transport beacon information material relating to a geographical position on the present route of the transportation platform;

b) receiving a signal related to the present geographical position of the transportation platform;

c) determining the present geographical position of the transportation platform;

d) repeating steps b) and c) and thereby computing the direction and speed of the transportation platform; and

e) transmitting to a user terminal on the transportation platform information material associated with a subsequent geographical position in relation to the present geographical position, speed and direction of the transportation platform.

As with previous methods, the above may be personalised in terms of the messages sent to (or accepted by) individual user terminals, for example to reflect individual language preferences, or details relevant to future stages of a journey. Travellers anticipating next and subsequent destinations en route of their journey may be provided information commensurate with their ability to assimilate or respond thereto—that is, information is provided in relation to present speed and direction. For example, a traveller on Eurostar™ which is presently travelling at 300 kmh (1 km every 12 seconds) needs information relating to locations tens of kilometers ahead (and 1-2 kilometers apart); this compares say with a bus where information relating to locations a few kilometers ahead (and a few tens of meters apart) is generally required. The system of the present invention may dynamically select information to be sent to the user according to the prevailing direction and speed of travel of the transportation platform, such that the granularity of detail provided may be varied appropriately. This has an added bonus in that additional information (still relevant to present geographical position, but finely detailed) may be selected and sent to users during those occasions where the transportation platform experiences delays or slower progress than planned.

Further in accordance with the present invention there is provided a method for performing customer surveys comprising the steps of:

a) providing the capability for travellers to leave messages for other travellers on the transport beacon/network;

b) receiving messages from user terminals on the transport beacon;

c) scanning said messages to identify those which include service related keywords; and

d) reviewing said messages identified to obtain customer survey data.

Getting responses to customer surveys which represent the true feelings of the person surveyed is a problem. In a further embodiment the present invention allows users to post messages to other users on the transport beacon: this option may only be made available at certain times or when the platform is in certain locations, corresponding to the availability that would arise if a series of fixed beacons were provided along the transport platforms route, rather than having a single transport beacon aboard—i.e. the transport beacon acts as proxy for several fixed beacons with a corresponding reduction in infrastructure cost whilst still supporting the same geographically configured data delivery system. The customer survey feature may allow the transport beacon, or some other facility (where the messages are forwarded on from the transport beacon) to scan the messages for keywords and the like relating to service aspects of the system of which the transportation platform forms a part. Those messages containing said keywords are then reviewed in more detail to obtain service related information possibly residing in the messages. In this way candid (and therefore valuable) feedback relating to service performance and the like might be obtained. Issues such as privacy may also need to be addressed for such an application, for example by the use of access codes to enable access for certain passengers to certain classes of information, or messages that have been left for those passengers. It should be noted in this context that a two-way interaction between the user terminal and transport beacon need not always occur, with information instead being broadcast as an RF signal from the transport beacon to any receiver in the vicinity.

Further in accordance with the present invention there is provided a method for communicating between user terminals on a transportation platform comprising the steps of:

a) sending data from a first user terminal to a transport beacon; and

b) relaying said data from the transport beacon to a second user terminal. This relaying may be from the same transport beacon direct to the second user terminal or it may be over a link to another transport beacon on the same transportation platform.

Typical user terminals are equipped with limited means of communication which must support different applications including that of the present invention. This might be compared to the PC where the COM (RS232) port is used for a whole gamut of applications. Where the communication port is wireless, a widely deployed solution is usually preferred by manufacturers to improve the likelihood that the user terminal will connect in any application chosen by the user; at the present time Bluetooth is a popular choice for a user terminal wireless communications port, although other protocols such as 802.11 are equally feasible. The present invention may facilitate the interconnection of Bluetooth equipped user terminals by the transport beacon acting as an interconnection node between user terminals riding a transportation platform that otherwise would be out of range of each other and therefore unable to communicate.

Further features and advantages will now be described, by way of example only, with reference to the accompanying drawings in which:

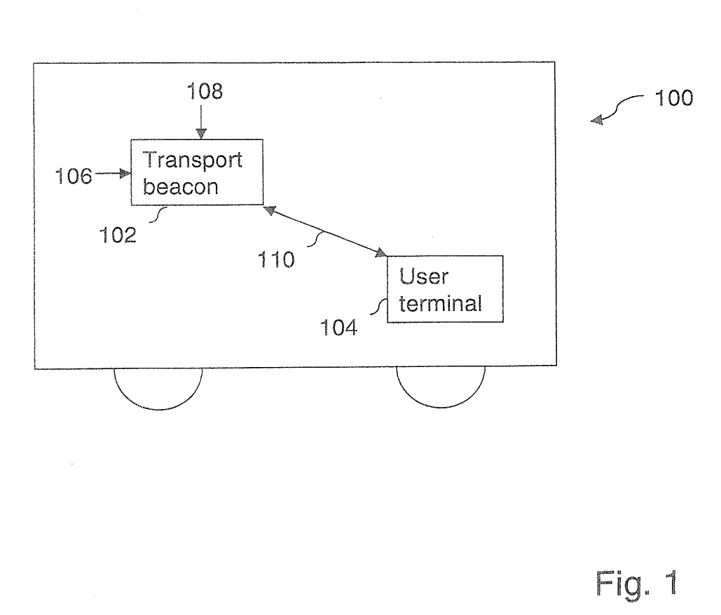

FIG. 1 is a schematic representation of a transportation platform suitable for use with the present invention;

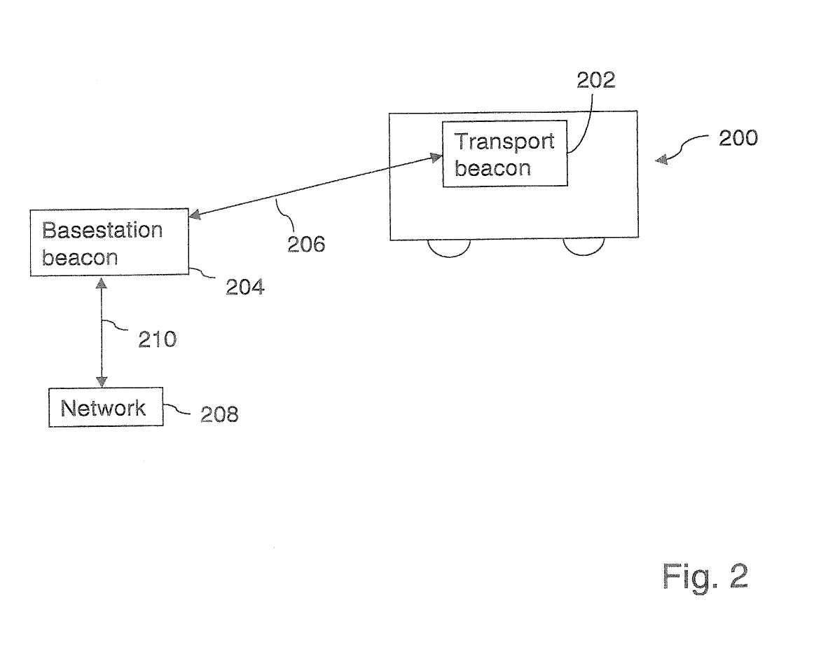

FIG. 2 is a schematic representation of an information system embodying the present invention;

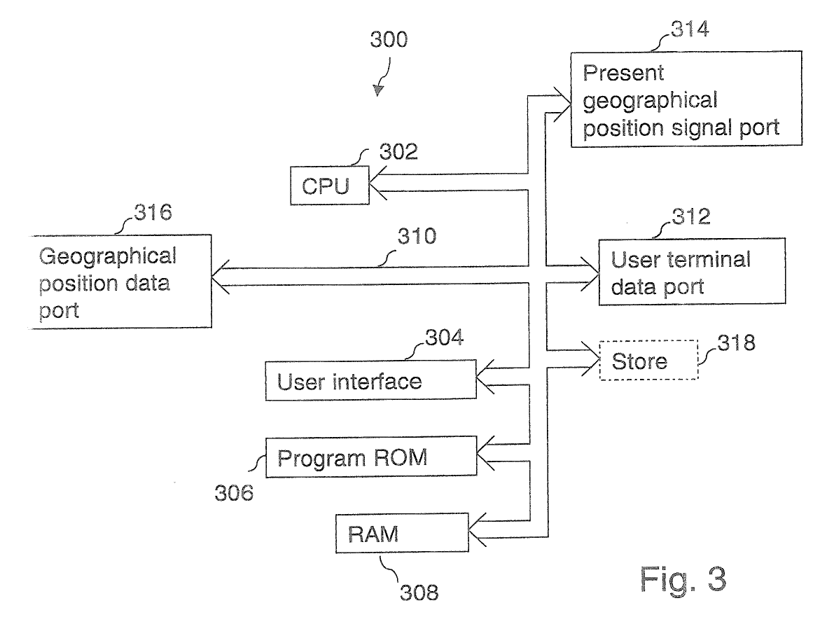

FIG. 3 is a schematic representation of features of the transport beacon apparatus according to the present invention; and

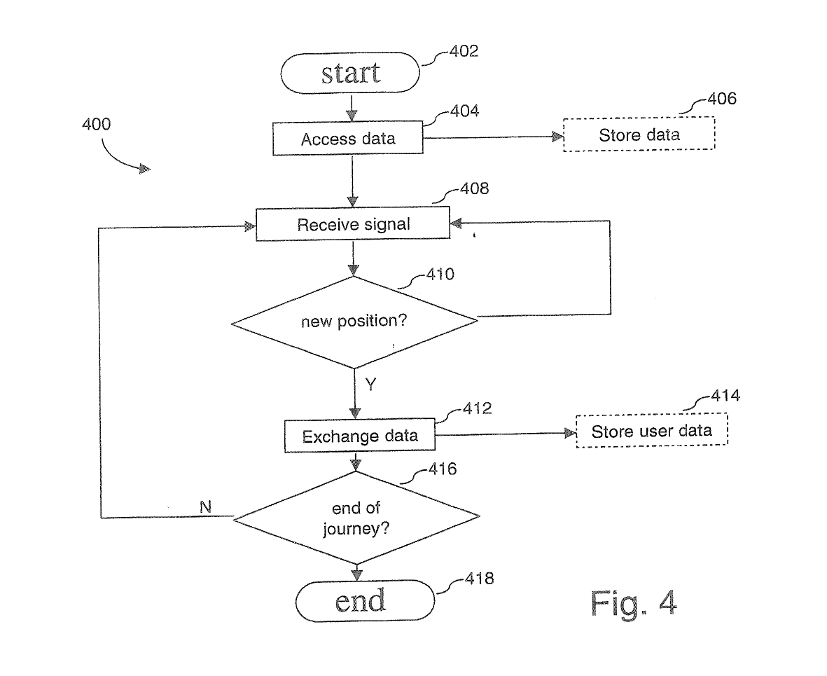

FIGS. 4-10 are flowcharts depicting various operational methods according to the present invention.

In the following description the term ‘transportation platform’ refers to any public or private vehicle used for travelling, including bus, truck, car, train, plane, ship, taxi. The term ‘transport beacon’ refers to an entity residing on a transportation platform which is able to communicate with a user terminal also riding the transportation platform. In a practical sense, a transport beacon may comprise several units interconnected and dispersed within the transportation platform so as to provide total coverage with (that is the ability to communicate with) any user terminal on the transportation platform. In this sense the collection of such units collaborating as one unit represents the meaning of ‘transport beacon’ as referred to in the present description (the means to achieve such collaboration being known in the art, but not disclosed herein as it will be readily understood by the skilled reader and lies outside the scope of the present invention). Communication with a user terminal may be by use of wired or wireless means. The term ‘basestation beacon’ refers to an entity which, in use, is sited at a fixed geographical position and is able to communicate with a transport beacon (when in range or otherwise connected thereto). Communication between basestation beacon and transport beacon may be by use of wired or wireless means. The term ‘data relating to a geographical position’ refers to information data intended for transfer to a user terminal (i.e. the user); it may include tourist information, schedules, advertising, etc. Clearly, in normal use data is provided for a plurality of geographical positions each of which may be passed by the route taken by the transportation platform.

FIG. 1 shows a transportation platform suitable for use with the present invention. The transportation platform 100 comprises a transport beacon 102 and a user terminal 104. Data associated with a geographical position 106 is provided by some source (for example, CD-ROM, HDD or basestation beacon, not shown in the Figure) and received by the transport beacon 102. Typically, data 106 would comprise data for a several geographical positions of the transportation platform (for example geographical positions of intermediate stops along the route of a bus or train). Preferably, data 106 is stored within the transport beacon. The transport beacon 102 receives a signal 108 related to the present geographical position of the transportation platform 100. The transport beacon 102 then compares the present geographical position with data 106; if there is a match, then the corresponding data is sent 110 to the user terminal 104. Should the user respond in some way to the data sent (for example responding to an advertisement) then this response is communicated back to the transport beacon. Thus an exchange of data 110 occurs between transport beacon and the user terminal in dependence on the present geographical position of the transportation platform as signalled 108 to the transport beacon. The transport beacon preferably communicates wirelessly with the user terminal.

FIG. 2 shows a schematic representation of an information system embodying the present invention. Transport beacon 202 situated on transportation platform 200 exchanges data 206 with basestation beacon 204 (when connected or, in the case of a wireless connection, when in range). In addition, the basestation beacon 204 exchanges data 210 with a network 208. It should be noted that the system does not require either a basestation beacon 204 or network 208 in order to function according to the present invention. For example, the transport beacon may periodically acquire data relating to geographical position prior to, or after, journeying its route. The transport beacon may include storage and/or a media player (e.g. a CD-ROM) from which to access the data during the trip along the route. Data exchanged with the basestation beacon may include, in any combination, data relating to geographical position, user data and a signal representing the geographical position of the basestation beacon. The network 208 may be wired or wireless and may connect to external wide area networks, including the Internet; in addition it may be implemented using passing transportation platforms as a means to communicate from one basestation beacon to another thereby updating all basestation beacons along the route (in-range path) of the transportation platform.

FIG. 3 shows a schematic representation of features of the transport beacon apparatus. The transport beacon apparatus comprises a data processor unit illustrated generally at 300, several communication ports 312, 314, 316 and an optional data store 318, all interconnected by a bus 310. The data processor unit 300 comprises CPU 302, rudimentary user interface 304 (for example used to verify basic functioning), program ROM 306 which stores computer program instructions for the transport beacon and RAM 308 to support the program execution by the CPU. Data port 312 is the port the transport beacon utilises to communicate with a user terminal; preferably this port utilises wireless communication, for example Bluetooth, IEEE802.11 or similar. Data port 314 receives a signal related to the present geographical position of the transportation platform. Preferably, this signal may be derived from the management system which controls the transportation platform. In this way, the transportation platform infrastructure is responsible for the timely provision of the signal along the route taken by the transportation platform. Alternatively, a separate subsystem, for example a GPS unit, may provide the signal. This is suitable for implementations where the transportation platform has access to GPS (for example, surface transportation); GPS is not appropriate for underground systems. In any event, for convenience, the signal presented at port 314 may be encoded as GPS. Data port 316 receives data related geographical position from a basestation beacon and /or local bulk storage readable media such as CD-ROM, HDD, etc. Data port 316 may also, in the case where it communicates with a basestation beacon, send user data and receive signals relating to the present geographical position of the transportation platform. The transport beacon may simply act a as “data conduit” relaying data from a source (for example a basestation beacon) to destination user terminal. In this scenario, data would only be available when the transport beacon was in range or otherwise connected to the basestation beacon. In preference, the transport beacon would also comprise a data store 318 to cache data relating to geographical position received from a basestation beacon or other source, which data would then be sent via port 312 to a user terminal in dependence on the present geographical position of the transportation platform as signalled at port 314.

FIG. 4 shows a flowchart describing a method 400 for exchanging data between a transport beacon and a user terminal according to an aspect of the present invention. The method starts at 402 and data relating to geographical position is accessed at 404 and optionally stored at 406 (as denoted by the broken outline, and also discussed earlier). A signal relating to the present geographical position of the transportation platform is received at 408 and the system determines at 410 if the signal relates to a new geographical position with respect to the immediately preceding signal received. If true, the transport beacon may exchange data 412 with the user terminal in dependence on the present geographical position; data received from the user terminal is optionally stored at 414. If false, the method cycles back to receive a successive signal related to the present geographical position at 408. The method then tests 416 for end of journey of the transportation platform, if true the method ends at 418. If false, the method cycles back to receive a successive signal related to the present geographical position at 408.

The optionally stored data at 414 may be used in profiling of users to permit filtering of data transmitted to the terminal: the stored data may comprise a profile accumulated purely from the results of previous interactions by the user terminal, or it may include specific profiling data downloaded by the user terminal to the transport beacon. In an alternative, more private, arrangement the transport beacon may not apply any filtering or store any user data: instead, filtering of messages/data is carried out purely in the user terminal, with only those meeting locally stored or generated profile criteria being presented to the user and the remainder simply discarded.

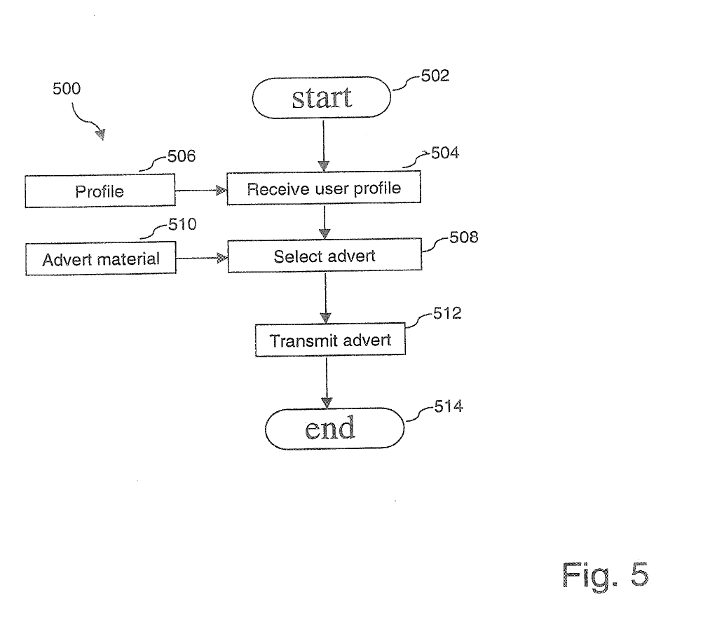

FIG. 5 shows a flowchart describing a method 500 for advertising to passengers riding a transportation platform. The method starts at 502 and advertisement material is available in store 510. The transport beacon receives 504 user profile data 506 from one or more user terminals riding the transportation platform. For each user profile received, the transport beacon selects an advertisement 508 from the stored advertisement material 510 and transmits the selected advertisement 512 to the user terminal corresponding to the user profile against which the advertisement was selected. The method ends at 514. Although not shown in FIG. 5, steps 504, 508 and 512 may be repeated as required during the journey of the transportation platform.

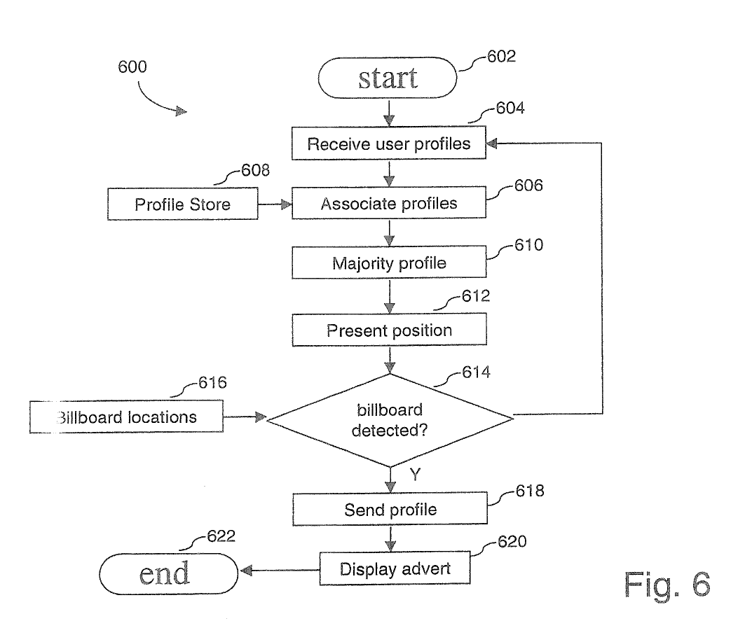

FIG. 6 shows a flowchart describing a method 600 for advertising to passengers riding a transportation platform via a billboard. The method starts at 602, a set of predetermined profiles is provided to the transport beacon in store 608. In addition a set of billboard locations (geographical positions) is provided in store 616. The user profile from one or more user terminals riding the transportation platform is received 604 by the transport beacon. The transport beacon then associates 606 each received user profile with a predetermined profile 608. The transport beacon then determines 610 a majority predetermined user profile corresponding to the present user population riding the transportation platform. Using the method earlier described the transport beacon determines its present geographical position 612 and checks 614 this against the geographical positions (locations) of known billboard sites stored at 616; if the transportation platform is proximate to a billboard, then the majority predetermined user profile is sent 618 to the billboard (maybe via an intermediate basestation beacon). The billboard then displays 620 an advertisement corresponding to the provided majority predetermined user profile thereby targeting travellers riding the transportation platform. In the case where a billboard is not proximate to the transportation platform, steps 604, 606, 610, 612 and 614 are repeated. The method ends at 622. Clearly, the method may be repeatedly executed during the travel of the transportation platform along its route.

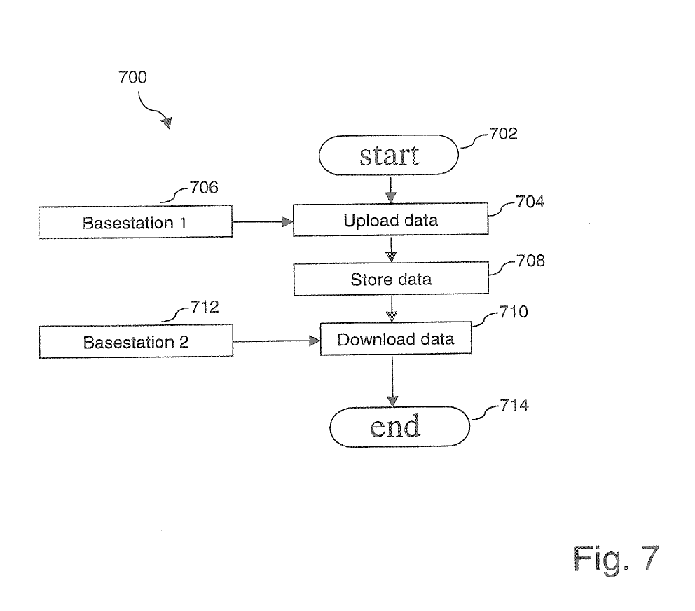

FIG. 7 shows a flowchart describing a method 700 for updating a basestation beacon utilising the transportation platform. The method starts at 702, data is uploaded 704 to the transport beacon from basestation beacon 1 706. At 708 the uploaded data is stored within the transport beacon. The transportation platform may subsequently move to another location to connect to (e.g. become in range of) basestation beacon 2 712. Data is then downloaded 710 from the transport beacon to basestation beacon 2. The method ends at 714. Where there are further basestation beacons to update, the method is repeated.

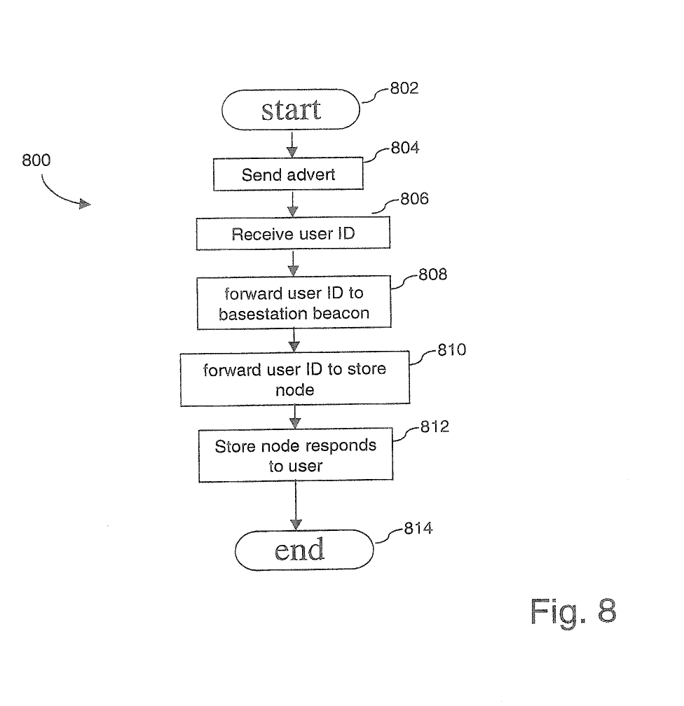

FIG. 8 shows a flowchart describing a method 800 for identifying to a user a store associated with an advertisement. The method starts at 802 and the transport beacon sends 804 an advertisement to a user terminal. The user responds to the advertisement and his/her user terminal sends a user ID which is received 806 by the transport beacon. The transport beacon then forwards 808 the user ID (along with the relevant store ID) to a basestation beacon which then in turn forwards 810 the user ID to the relevant store node corresponding to the store ID. The store node then responds back to the user 812 for example, by prominently displaying the user ID in a position proximate to the store, or perhaps by calling the user on his/her mobile phone (e.g. where the user ID includes the mobile phone number of the user). In an alternative embodiment, the transport beacon communicates directly with the store node. The method ends at 814. The method would typically be repeatedly executed during the travel of the transportation platform.

In an alternative or addition to the arrangement of FIG. 8, rather than requiring the user to respond directly to the advertisement when received, the user terminal may be provided with a facility (suitably a one button operation) to capture contact details for an advertisement of interest. These contact details (for example WAN access information) may subsequently be recalled by the user to facilitate interaction between the user and store node via (for example) the internet. In addition to these contact details, the transport beacon may make available to the user terminal privileged offers of information, goods or services to provide an incentive to the user interacting with the store node at a later time.

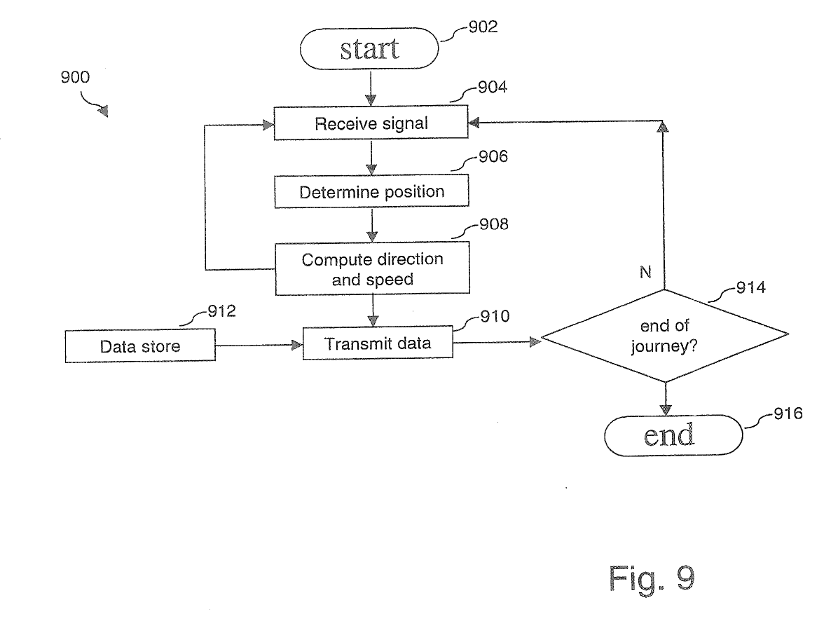

FIG. 9 shows a flowchart describing a method 900 for advanced notification of passengers riding a transportation platform. The method starts at 902 and data relating to geographical position is available in store 912. A signal relating to the present geographical position of the transportation platform is received 904 and the present position of the transportation platform is determined 906. Over several iterations of 904 and 906 the present speed and direction of the transportation platform is computed 908 and selected data from store 912 relating to geographical position is transmitted 910 in accordance with the present geographical position, speed and direction of the transportation platform. In this way, the correct fineness or granularity of information relating to upcoming waypoints en route is sent to user terminals, with that information being delivered at a suitable time prior to arrival at such waypoints (again derived from the speed and direction). The process 904, 906, 908 and 910 continues until the transportation platform arrives at its final destination 914. The method ends at 916.

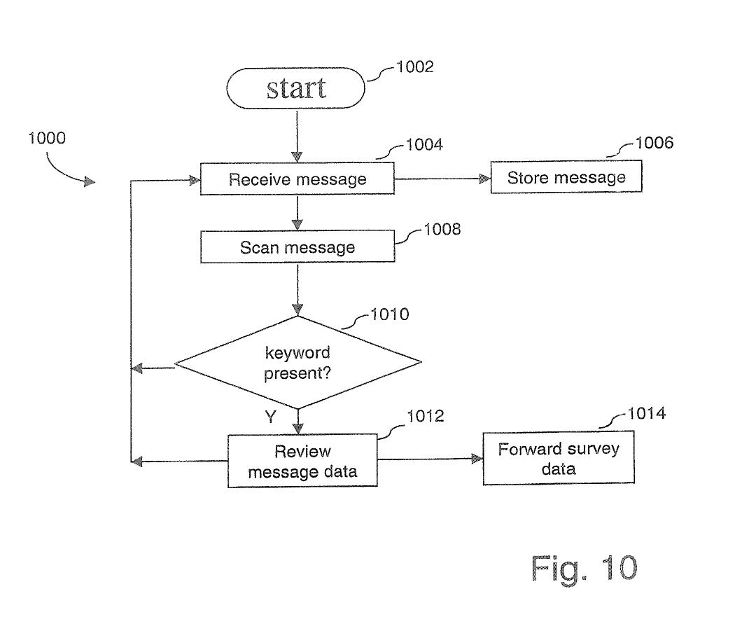

FIG. 10 shows a flowchart describing a method 1000 for performing surveys of passengers riding a transportation platform. The method starts at 1002. Passengers are able to compose messages for other passengers (present or future riders on the transportation platform) and post these to the transport beacon on the transportation platform. The transport beacon receives 1004 and stores 1006 a message. The transport beacon scans 1008 the message to identify 1010 if it contains one or more selected keywords, for example relating to service performance of the transportation platform system. Where this is the case, the transport beacon then reviews 1012 in more detail the identified message to obtain for example customer satisfaction data. This acquired survey data may be augmented in the system, for example with information as to the time, date, and/or location at which the message was sent or analysed by the transport beacon. Such message tagging may also be useful for user terminals receiving messages left by other users to enable selection of only recent messages or those from particular persons known to be in specific locations. Acquired survey data is forwarded 1014 to for example the transportation platform operator for analysis. The method continuously executes to scan and where necessary review each message received.

The foregoing methods are presented by way of example only and represent a selection of a range of methods that can readily be modified by a person skilled in the art to exploit the advantages of the system as disclosed in the present invention.

In the description above and with reference to FIG. 1, an apparatus, use and methods are described in relation to a data transmission system for a transportation platform 100 comprising a transport beacon 102 and a user terminal 104, the transport beacon and user terminal being carried on the transportation platform 100, the transport beacon operable to access data associated with a geographical position 106, to receive a signal relating to the present geographical position 108 of the transportation platform and to exchange the data 110 with the user terminal in response to the signal.

1. A data transmission system for a transportation platform comprising a transport beacon and a user terminal, the transport beacon and user terminal being carried on the transportation platform, the transport beacon operable to access data associated with a geographical position, to receive a signal relating to the present geographical position of the transportation platform and to exchange said data with the user terminal in response to said signal.

2. A system as claimed in claim 1 comprising a basestation beacon, the basestation beacon operable to exchange data with the transport beacon.

3. A transport beacon for a transportation platform for use in the system of claim 1 comprising a data processing unit, a first communications port operable to support communications with a user terminal, a second communications port operable to receive a signal relating to the present geographical position of the transportation platform and a third communications port operable to access data associated with a geographical position and to exchange said data with the user terminal in response to said signal.

4. A transport beacon as claimed in claim 3 in which the signal relating to the present geographical position is provided by a system related to the management of the transportation platform.

5. A transport beacon as claimed in claim 3 comprising a GPS unit, which GPS unit provides the signal relating to the present geographical position.

6. A transport beacon as claimed in claim 3 comprising a store for data associated with a geographical position.

7. A basestation beacon for use in the system of claim 1 comprising a store for data associated with a geographical position and a communications port operable to support communications with a transport beacon.

8. A use of a transport beacon according to the system of claim 1 to deliver user services and advertising to travellers on a transportation platform, the use comprising:
the accessing of data associated with a geographical position of the transportation platform;
the reception of a signal relating to the present geographical position of the transportation platform; and
the exchange of said data with a user terminal residing on the transportation platform in dependence of the present geographical position of the transportation platform.

9. A use of a transport beacon as claimed in claim 8 wherein the exchange of said data with the user terminal is in addition in response to the current date and time.

10. A method for use in the system of claim 1 for delivering personalised data services and adverts to travellers, the method supported by a transport beacon and a user terminal residing on a transportation platform, the method comprising the steps of:
a) accessing data associated with a geographical position along the route of the transportation platform;
b) receiving a signal related to the present geographical position of the transportation platform; and
c) exchanging data related to a geographical position along the route of the transportation platform between the transport beacon and the user terminal in response to said signal.

11. A method as claimed in claim 10 wherein the exchange of said data with the user terminal is in addition in response to the current date and time.

12. A method as claimed in claim 10 or 11 comprising the steps of storing data comprising a profile and filtering data transmitted to the terminal in response to said profile.

13. A method as claimed in claim 10 or 11 comprising the step of filtering said exchanged data in the user terminal in response to a local profile.

14. A method for use in the system of claim 1 for creating virtual advertising space comprising the steps of:
a) providing to a transport beacon on a transportation platform advertising material relating to a geographical position;
b) detecting the present geographical position of the transportation platform; and
c) transmitting to a user terminal on the transportation platform advertising material in response to the present geographical position.

15. A method as claimed in claim 14 wherein said advertising material is transmitted to the user terminal in addition in response to the current date and time.

16. A method for use in the system of claim 1 for updating basestation beacons utilising a transport beacon carried on a transportation platform comprising the steps of:
a) uploading to the transport beacon update data from a first basestation beacon;
b) storing the update data within the transport beacon; and
c) downloading to a second basestation beacon the update data from the transport beacon.

17. A method for use in the system of claim 1 for identifying to a user a store associated with an advertisement comprising the steps of:
a) sending an advertisement from the transport beacon to a user terminal;
b) receiving at the transport beacon a user identity data accompanying a user response to said advertisement;
c) forwarding the user identity data from the transport beacon to a basestation beacon;
d) sending the user identity data from the basestation beacon to a store node; and
e) receiving the user identity data at the store node and the store node responding to the user.

18. A method as claimed in claim 17 in which the user identity data comprises a user mobile phone number which is dialled by the store node to call the user who is travelling nearby.

19. A method for use in the system of claim 1 for configuring billboard advertising to correspond with a profile of nearby travellers comprising the steps of:
a) providing a set of pre-defined user profiles;
b) providing a set of billboard locations;
c) receiving by a transport beacon a user profile from a user terminal;
d) associating the received user profile with a user profile group;
e) determining an appropriate user profile group corresponding to the present user population riding the transportation platform;
f) detecting the present geographical position of the transportation platform;
g) detecting the proximity of a billboard to the transportation platform;
h) exchanging said appropriate user profile group identity between the transport beacon and a basestation beacon;
i) exchanging said appropriate user profile group identity between the basestation beacon and the billboard; and
j) displaying on the billboard an advertisement corresponding to said appropriate user profile group identity.

20. A method for use in the system of claim 1 for advance notification of users of upcoming information on the route of a transportation platform comprising the steps of:
a) providing to a transport beacon information material relating to a geographical position on the present route of the transportation platform;
b) receiving a signal related to the present geographical position of the transportation platform;
c) determining the present geographical position of the transportation platform;
d) repeating steps b) and c) and thereby computing the direction and speed of the transportation platform; and
e) transmitting to a user terminal on the transportation platform information material associated with a subsequent geographical position in relation to the present geographical position, speed and direction of the transportation platform.

21. A method for use in the system of claim 1 for performing customer surveys comprising the steps of:
a) providing the capability for travellers to leave messages for other travellers on the transport beacon/network;
b) receiving messages from user terminals on the transport beacon;
c) scanning said messages to identify those which include service related keywords; and
d) reviewing said messages identified to obtain customer survey data.

22. A method for use in the system of claim 1 wherein a user can post a message to another user on the transport beacon.
